(19) United States
(12) Patent Application Publication
(10) Pub. No.: US 2004/0177092 A1
(43) Pub. Date: Sep. 9, 2004

(54) Apparatus and method for theorem certification without disclosing documents that lead to the theorem

(76) Inventor: Mathias Salle, Palo Alto, CA (US)

Correspondence Address: HEWLETT-PACKARD DEVELOPMENT COMPANY, Intellectual Propety Administration, P.O. Box 272400, Fort Collins, CO, 80527-2400, US

(21) Appl. No.: 10/379,212

(22) Filed: Mar. 5, 2003

(51) Int. Cl. G06F 17/00

(52) U.S. Cl. 707/104.1

(57) ABSTRACT

A method and corresponding apparatus for theorem certification enable the exchange of statements or conclusions between companies without the need for an issuing company to disclose facts or business documents that lead to these statements or conclusions. The method uses a trusted system to prove and verify statements issued by the issuing company using a set of business rules and business documents. The trusted system then passes the proved statements to a receiving company without disclosing the business documents that lead to the proved statements.

### CROSS-REFERENCE TO RELATED APPLICATIONS

This application is related to U.S. patent application Ser. No. 10/______ (Attorney Docket No. 200207986-1), entitled “METHOD AND SYSTEM FOR EVALUATING PERFORMANCE OF A WEBSITE USING A CUSTOMER SEGMENT AGENT TO INTERACT WITH THE WEBSITE ACCORDING TO A BEHAVIOR MODEL” to Cipriano SANTOS, et al.; U.S. patent application Ser. No. 10/______ (Attorney Docket No. 200207987-1), entitled “METHOD AND SYSTEM FOR CUSTOMIZED CONFIGURATION OF AN APPEARANCE OF A WEBSITE FOR A USER” to Evan KIRSHENBAUM, et al.; U.S. patent application Ser. No. 10/______ (Attorney Docket No. 200207988-1), entitled “SYSTEM, METHOD AND APPARATUS USING BIOMETRICS TO COMMUNICATE CUSTOMER DISSATISFACTION VIA STRESS LEVEL” to Carol McKENNAN, et al.; U.S. patent application Ser. No. 10/______ (Attorney Docket No. 200207993-1), entitled “METHOD AND SYSTEM FOR SELLING AN ITEM OVER A COMPUTER NETWORK” to Evan KIRSHENBAUM, et al.; U.S. patent application Ser. No. 10/______ (Attorney Docket No. 200207994-1), entitled “METHOD AND SYSTEM ENABLING THE TRADING OF A RIGHT TO PURCHASE GOODS OR SERVICES” to Robert C. VACANTE, et al.; U.S. patent application Ser. No. 10/______ (Attorney Docket No. 200207996-1), entitled “METHOD AND SYSTEM FOR PROCESSING USER FEEDBACK RECEIVED FROM A USER OF A WEBSITE” to Mathias SALLE, et al., and U.S. patent application Ser. No. 10/______ (Attorney Docket No. 200309361-1), entitled “A METHOD AND SYSTEM ENABLING THE TRADING OF A FUTURES CONTRACT FOR THE PURCHASE OF GOODS OR SERVICES” to Robert C. VACANTE, et al., all of which are concurrently herewith being filed under separate covers, the subject matters of which are herein incorporated by reference.

### TECHNICAL FIELD

The technical field relates to trusted exchange of information between computer systems, and, in particular, to theorem certification without disclosing documents that lead to the theorem.

### BACKGROUND

Companies share more and more information over the Internet. Increasingly, however, companies prefer to share conclusions and statements (theorem) with business partners without having to completely disclose facts or business documents that lead to the conclusions. The business documents that establish the conclusions and statements may be, for example, confidential information that should not be disclosed. However, it is also important that the business partners can trust the conclusions and statements presented by the company issuing such conclusions and statements.

For example, a sales contract may establish that a buyer pays a seller for the delivery of certain goods. The buyer has a right to delivery only after the seller secures the payment. The buyer typically sends a documentary credit application to an issuing bank. The issuing bank may issue a statement to the seller through an advising bank stating that the buyer's credit history can support such a line-of-credit, therefore delivery of goods is warranted. The statement is typically based on internal documents available at the issuing bank. On the one hand, the issuing bank may not want the seller or the advising bank to read the internal documents that lead to the statement. On the other hand, the seller and the advising bank may want to verify whether the statement is true before releasing the goods. Therefore, a trusted system is needed that enables the issuing bank to exchange the statement with the seller or the advising bank without having to disclose the internal documents that lead to the statement.

### SUMMARY

A method for theorem certification without disclosing business documents that lead to the theorem includes generating a proof to prove a statement in an issuer module. The proof is a set of business rules defined over a plurality of business documents in the issuer module. If the statement is proven to be true, the statement is referred to as a theorem. The method then generates a certified document containing the theorem and the proof that proves the theorem. The method further includes generating a signature of the certified document using a private key, verifying the signature in a receiver module using one or more public keys, and validating the proof that proves the theorem if the signature is valid.

A corresponding apparatus for theorem certification includes an issuer module that receives a statement to be proved. The issuer module includes a theorem prover that proves the statement using a proof, which is a set of business rules defined over business documents. If the statement is proven to be true, the statement is referred to as a theorem. The theorem prover then generates a certified document containing the theorem and the proof that proves the theorem. The issuer module further includes a theorem certifier that generates a signature of the certified document using a private key. The apparatus further includes a receiver module that verifies the signature using one or more public keys and validates the proof that proves the theorem.

### DESCRIPTION OF THE DRAWINGS

The preferred embodiments of the method and apparatus for theorem certification will be described in detail with reference to the following figures, in which like numerals refer to like elements, and wherein:

FIG. 1 illustrates an exemplary trusted system that proves and verifies a statement without disclosing business documents that lead to the statement;

FIG. 2 is a general flow chart illustrating how an issuing company uses the exemplary trusted system of FIG. 1 to certify a theorem for a receiving company;

FIGS. 3A and 3B are flow charts illustrating exemplary operations of the issuer module and the receiver module, respectively, of the exemplary trusted system of FIG. 1; and

FIG. 4 illustrates exemplary hardware components of a computer that may be used in connection with the method for theorem certification.

### DETAILED DESCRIPTION

A method and corresponding apparatus for theorem certification enable the exchange of statements or conclusions between companies without the need for an issuing company to disclose facts or business documents that lead to these statements or conclusions. The method uses a trusted system to prove and verify statements issued by the issuing company using a set of business rules and business documents. The trusted system then passes the proved statements to a receiving company without disclosing the business documents that lead to the proved statements.

The trusted system may be deployed within the issuing company and the receiving company. During the deployment phase, the issuing company and the receiving company may specify the company's own business rules by adding business rules to a business rule database. The business rule database may be located remotely or within the issuing company or the receiving company. Two different trusted systems may be deployed with completely different sets of business rules.

The trusted system may reside on a remote location server. The trusted system may also reside on a computer of the issuing company or a computer of the receiving company.

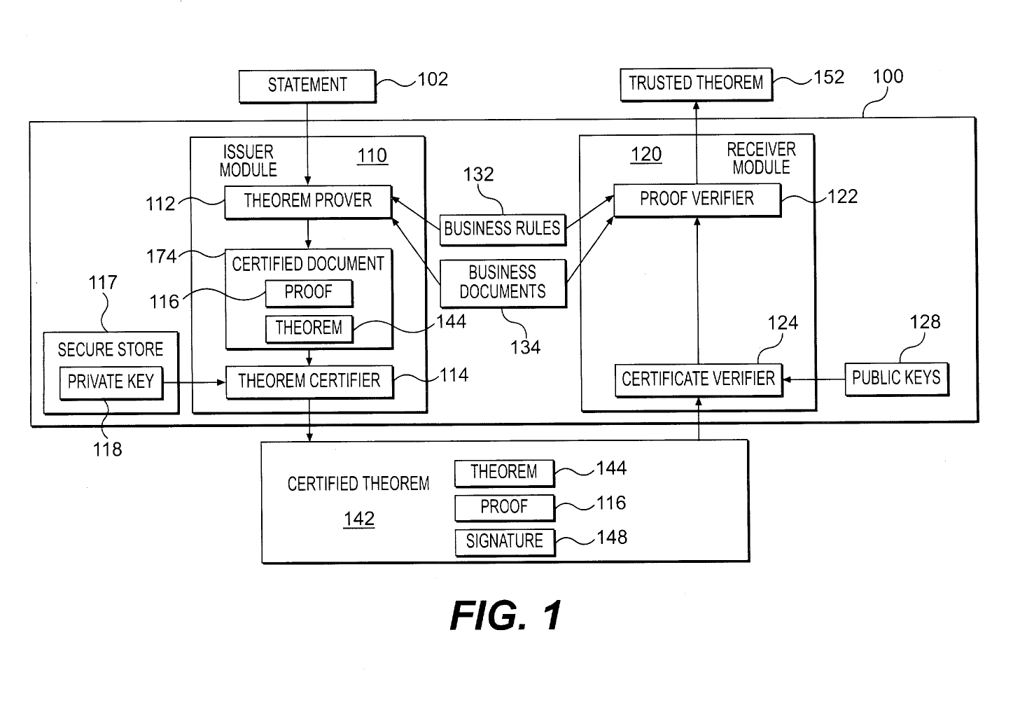

FIG. 1 illustrates an exemplary trusted system 100 that proves and verifies a statement without disclosing business documents that lead to the statement. The exemplary trusted system 100 facilitates exchange of information between an issuing company and a receiving company for illustration purposes only. One skilled in the art will appreciate that the issuing company may use the trusted system 100 to certify statements for multiple receiving companies in a similar fashion.

The trusted system 100 may include an issuer module 110 and a receiver module 120. The trusted system 100 may also include a database for business rules 132 expressed, for example, in a logical format, and a database for business documents 134. In addition, the system 100 may include a database for public keys 128 and a secure store 117 holding a private key 118 used by the issuing company to issue certificates.

When an issuing company issues a statement 102 for a receiving company, the trusted system 100 may input the statement 102 to the issuer module 110. The statement 102 may be, for example, “buyer's credit history can support such a line-of-credit.” The statement 102 may contain logical formula to be proved by a theorem prover 112. A theorem prover 112 is typically a system that answers questions posed as logical formulas. Specifically, the theorem prover 112 may use a proof 116 to prove that the statement 102 is true. The proof 116 may be a set of business rules 132 defined over the business documents 134, which are typically expressed in a logical language.

After the theorem prover 112 proves the statement 102 to be true using the proof 116, the statement 102 is referred to as a theorem 144. Next, a certified document 174 is generated containing the theorem 144 and the proof 116 that proves the theorem 144.

Thereafter, the theorem 144 is inputted to a theorem certifier 114. The theorem certifier 114 may be a cryptographic device that uses the theorem 144 and the proof 116 to generate a signed certificate, i.e., a certified theorem 142. The theorem certifier 114 may encrypt the certified document 174 with the private key 118 to generate a signature 148. The certified theorem 142 may contain the theorem 144, the proof 116 that proves the theorem 144, and the signature 148.

After the certified theorem 142 is created, the certified theorem 142 may be sent to the receiving company. The receiving company inputs the certified theorem 142 to the receiver module 120 of the trusted system 100. The receiver module 120 may include a certificate verifier 124, which is cryptographic device that verifies the validity of a certified theorem 142 using a set of public keys 128. For example, the trusted system 100 may include a private key (sk), a public key (pk), and a certified document (m) containing a theorem 144 and the proof 116. To generate a signature (s), the theorem certifier 114 encrypts the certified document (m) with the private key (sk) using a formula, such as s:=Esk(m). To verify the signature (s), the certificate verifier 124 decrypts the signature using a formula, such as q:=Epk(s), and determines whether q equates to m. If q equates to m, the signature (s) is accepted as valid. In this example, Esk corresponds to the encryption operation using the key sk, whereas Epk is the decryption operation using the key pk.

After the signature 148 is proven to be valid, the certified theorem 142 is passed to a proof verifier 122. The proof verifier 122 is a system that verifies if the proof 116 is valid with regard to the business rules 132 defined in the receiver module 120. Given a set of business rules 132 in the receiver module 120, of the form “conclusion if premise”, for example, a proof 116 is valid with regard to the business rules 132 if the set of business rules 132 can establish the same conclusion based on the same premises for each formula used in the proof 116.

If the proof 116 is valid, i.e., the receiver module 120 contains the same set of business rules 132 that prove the theorem 144, the receiver module 120 generates a trusted theorem 152. If the proof 116 is not valid, the receiver module 120 rejects the certified theorem 142.

The following is an example illustrating the method for theorem certification between two companies, an issuing company C1 and a receiving company C2.

A set of the business rules 132 in C1 may be:

1. Take_Delivery(buyer,good) if

contract(buyer,seller,good),send(buyer, issuing_bank,document_credit_applicatio n(buyer, issuing_bank)),pay(buyer, issuing bank)

2. send(buyer, issuing_bank,document_credit_application(buyer, issuing_bank)) if

Document_credit_application(buyer,issuing_bank)

3. pay(buyer, issuing_bank) if Receipt_of_Payment(buyer, issuing_bank)

In this example, C1 possesses the following business documents 134:

Contract(C2,C1,book)

Document_credit_application(C2,Bank_of_America)

Receipt_of_Payment(C2,Bank_of_America)

C1 may issue the following statement 102: Take_Delivery(C1,book). The proof 116 to be attached to that statement 102 may be:

Take_Delivery(C1,book) if

contract(C2, C1, book),send(C1,Bank_of_America, document_credit_application(C 1,Bank_of_America)),pay(C1,Bank_of_America)

send(C1,Bank_of_America,document_credit application(C1,Bank_of_America))

if Document_credit_application(C1,Bank_of_America)

pay(C1,Bank_of_America) if Receipt_of_Payment(C1,Bank_of_America)

The trusted system 100 may prove the statement 102 using the proof 116 and pass the proved statement 102 to a receiving company without disclosing the business documents 134 involved.

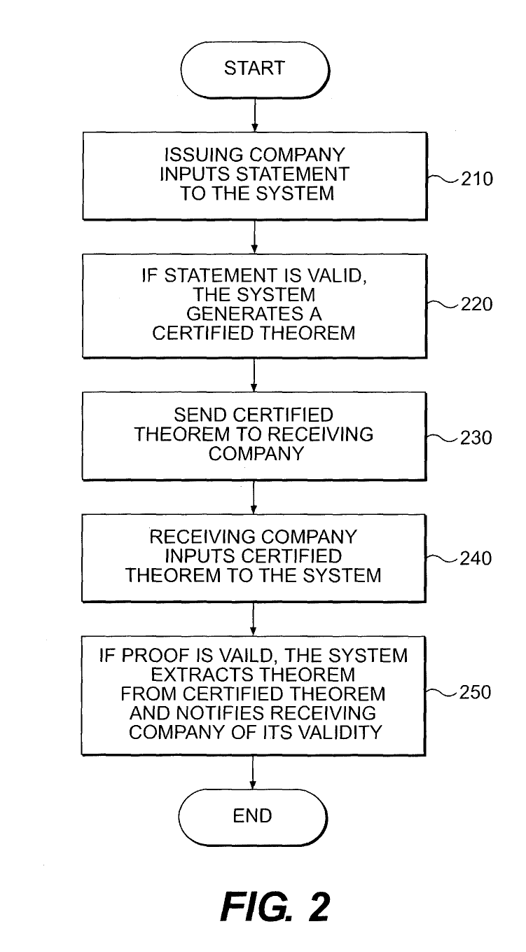

FIG. 2 is a general flow chart illustrating how an issuing company uses the exemplary trusted system 100 to certify a theorem 144 for a receiving company. The issuing company first inputs the statement 102 to the issuer module 110 of the trusted system 100 (block 210). If the statement 102 is valid, the statement 102 is referred to as a theorem 144. The trusted system 100 then generates a certified theorem 142 containing the theorem 144 and proof 116 that proves the theorem 144 (block 220). Next, the certified theorem 142 may be sent to the receiving company (block 230). The receiving company inputs the certified theorem 142 to a receiver module 120 of the trusted system 100 to verify the proof 116 that proves the statement 102 (block 240). If the proof 116 is valid, the trusted system 100 extracts the theorem 144 from the certified theorem 142 and notifies the receiving company of the theorem's validity (block 250).

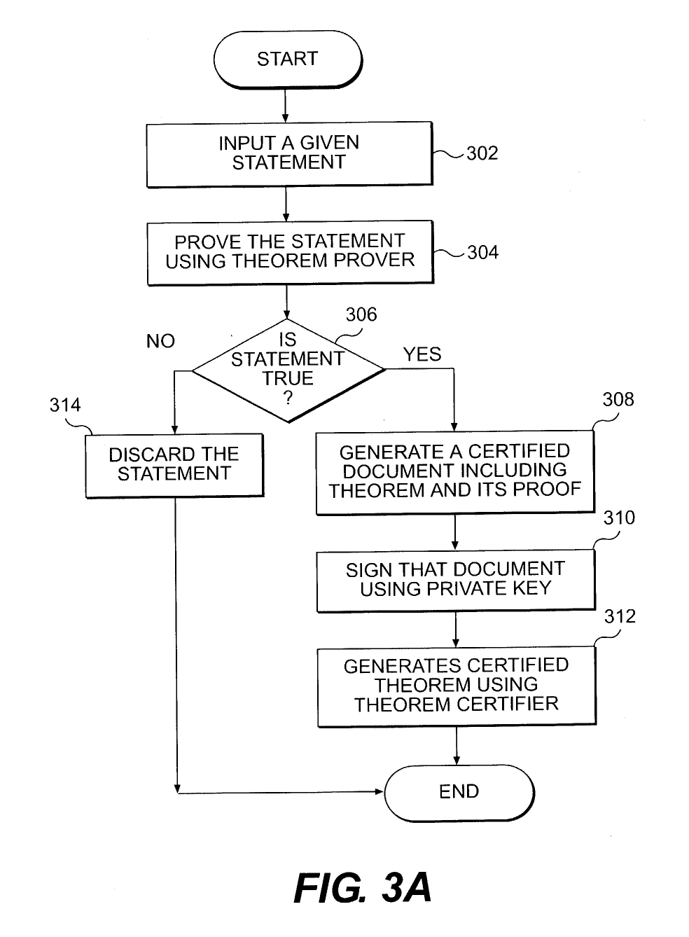

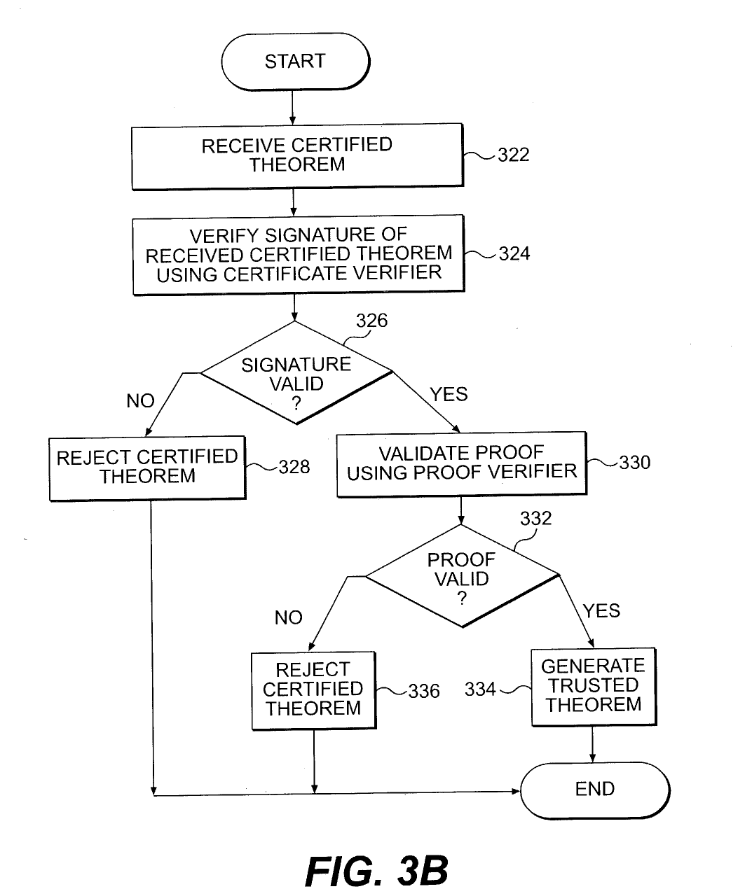

FIGS. 3A and 3B are flow charts illustrating exemplary operations of the issuer module 110 and the receiver module 120, respectively, of the exemplary trusted system 100. Referring to FIG. 3A, after a statement 102 is inputted to the issuer module 110 (block 302), the theorem prover 112 proves the statement 102 using the proof 116 that is a set of business rules 132 defined over the business documents 134 (block 304). If the statement 102 is proved to be true, the statement 102 is referred to as a theorem 144 (block 306). The theorem prover 112 then generates a certified document 174 containing the theorem 144 and the proof 116 (block 308). If the statement 102 is not true (block 306), the statement 102 is discarded (block 314). After the certified document 174 is generated, the theorem certifier 114 signs the certified document 174 using a private key 118 (block 310) and generates a certified theorem 142 containing the theorem 144, the proof 116, and the signature 148 (block 312).

Referring to FIG. 3B, after the receiver module 120 receives the certified theorem 142 (block 322), the certificate verifier 124 verifies the signature 148 of the received certified theorem 142 (block 324). If the signature 148 is valid (block 326), the certified theorem 142 is passed to the proof verifier 122, which validates the proof 116 that proves the theorem 144 (block 330). If the signature 148 is invalid (block 326), the certificate verifier 124 rejects the certified theorem 142 (block 328). If the proof 116 is valid (block 332), the proof verifier generates a trusted theorem 152 to be passed to the receiving company (block 334). On the other hand, if the proof 116 is invalid, i.e., the receiver module 120 does not contain the same set of business rules 132 that prove the theorem 144 (block 332), the proof verifier 122 rejects the certified theorem 142 (block 336).

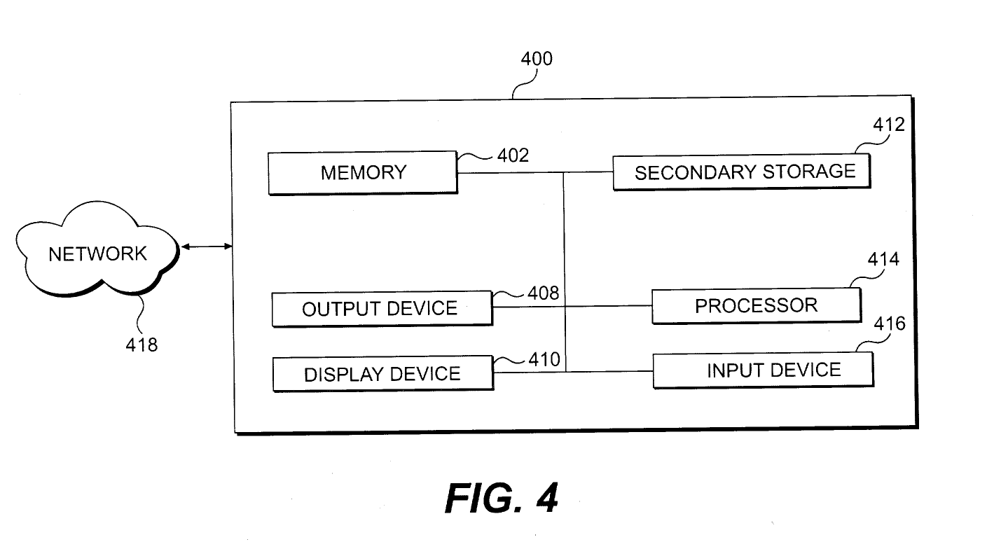

FIG. 4 illustrates exemplary hardware components of a computer 400 that may be used in connection with the method for theorem certification. The computer 400 includes a connection with a network 418 such as the Internet or other type of computer or telephone network. The computer 400 typically includes a memory 402, a secondary storage device 412, a processor 414, an input device 416, a display device 410, and an output device 408.

The memory 402 may include random access memory (RAM) or similar types of memory. The secondary storage device 412 may include a hard disk drive, floppy disk drive, CD-ROM drive, or other types of non-volatile data storage, and may correspond with various databases or other resources. The processor 414 may execute information stored in the memory 402, the secondary storage 412, or received from the Internet or other network 418. The input device 416 may include any device for entering data into the computer 400, such as a keyboard, keypad, cursor-control device, touch-screen (possibly with a stylus), or microphone. The display device 410 may include any type of device for presenting visual image, such as, for example, a computer monitor, flat-screen display, or display panel. The output device 408 may include any type of device for presenting data in hard copy format, such as a printer, and other types of output devices including speakers or any device for providing data in audio form. The computer 400 can possibly include multiple input devices, output devices, and display devices.

Although the computer 400 is depicted with various components, one skilled in the art will appreciate that the computer 400 can contain additional or different components. In addition, although aspects of an implementation consistent with the method for theorem certification are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling the computer 400 to perform a particular method.

While the method and apparatus for theorem certification have been described in connection with an exemplary embodiment, those skilled in the art will understand that many modifications in light of these teachings are possible, and this application is intended to cover any variations thereof.

What is claimed is:

1. A method for theorem certification without disclosing business documents that lead to the theorem, comprising:
generating a proof to prove a statement in an issuer module, wherein the proof is a set of business rules defined over a plurality of business documents in the issuer module, and if the statement is true, the statement is a theorem;
generating a certified document containing the theorem and the proof that proves the theorem;
generating a signature of the certified document using a private key;
verifying the signature in a receiver module using public keys; and
if the signature is valid, validating the proof that proves the theorem.

2. The method of claim 1, further comprising generating a signed certified document by combining the certified document and the signature.

3. The method of claim 1, wherein the generating the signature step includes using a theorem certifier to generate the signature for the certified document.

4. The method of claim 1, further comprising generating a certified theorem using a theorem certifier, wherein the certified theorem contains the theorem, the proof, and the signature.

5. The method of claim 4, further comprising rejecting the certified theorem if the signature is invalid.

6. The method of claim 4, further comprising rejecting the certified theorem if the proof is invalid.

7. The method of claim 1, wherein the verifying step includes using a certificate verifier to verify the signature in the receiver module.

8. The method of claim 1, wherein the validating step includes using a proof verifier to validate the proof, wherein the proof is valid if the receiver module contains a same set of business rules that prove the theorem.

9. The method of claim 1, further comprising generating a trusted theorem if the proof is valid.

10. An apparatus for theorem certification without disclosing business documents that lead to the theorem, comprising:
an issuer module that receives a statement to be proved, the issuer module comprising:
a theorem prover that generates a proof to prove the statement, wherein the proof is a set of business rules defined over a plurality of business documents, and wherein if the statement is true, the statement is a theorem and the theorem prover generates a certified document containing the theorem and the proof that proves the theorem; and
a theorem certifier that generates a signature of the certified document using a private key; and
a receiver module that verifies the signature using one or more public keys and validates the proof that proves the theorem.

11. The apparatus of claim 10, wherein the receiver module includes a certificate verifier that verifies the signature.

12. The apparatus of claim 10, wherein the receiver module includes a proof verifier that validates the proof, wherein the proof is valid if the receiver module contains a same set of business rules that prove the theorem.

13. The apparatus of claim 10, wherein the receiver module generates a trusted theorem if the proof is valid.

14. The apparatus of claim 10, wherein the theorem certifier generates a certified theorem, wherein the certified theorem contains the theorem, the proof, and the signature.

15. The apparatus of claim 14, wherein the receiver module rejects the certified theorem is the signature is invalid.

16. The apparatus of claim 14, wherein the receiver module rejects the certified theorem if the proof is invalid.

17. A computer readable medium providing instructions for theorem certification without disclosing business documents that lead to the theorem, the instructions comprising:
generating a proof to prove a statement in an issuer module, wherein the proof is a set of business rules defined over a plurality of business documents in the issuer module, and if the statement is true, the statement is a theorem;
generating a certified document containing the theorem and the proof that proves the theorem;
generating a signature of the certified document using a private key;
verifying the signature in a receiver module using public keys; and
if the signature is valid, validating the proof that proves the theorem.

18. The computer readable medium of claim 17, further comprising instructions for generating a certified theorem using a theorem certifier, wherein the certified theorem contains the theorem, the proof, and the signature.

19. The computer readable medium of claim 17, wherein the instructions for validating include instructions for using a proof verifier to validate the proof, wherein the proof is valid if the receiver module contains a same set of business rules that prove the theorem.

20. The computer readable medium of claim 17, further comprising instructions for generating a trusted theorem if the proof is valid.
